(19) United States
(12) Patent Application Publication
(10) Pub. No.: US 2026/0338656 A1
(43) Pub. Date: Oct. 29, 2026

(54) Apparatus and method for preparing tissue samples for frozen sectioning

(71) Applicant: Debra Lee Keith, Mesa, AZ (US)

(72) Inventor: Debra Lee Keith, Mesa, AZ (US)

(21) Appl. No.: 19/190,782

(22) Filed: Apr. 27, 2025

(51) Int. Cl. G01N 1/42; G01N 1/36

(52) U.S. Cl. CPC G01N 1/42; G01N 1/36

(57) ABSTRACT

An apparatus that consists of a flat aluminum heatsink plane, two adjustable specimen frames, and one over-tissue heat extraction cylinder. Tissue is placed flat on the heatsink plane, captured by adjustable specimen frames spaced to allow for minimum embedding medium use. The specimen frame is filled with an embedding medium. The cryostat manufacturer-supplied chuck is placed on the specimen. The over-tissue heat extraction cylinder is placed on the chuck, and the tissue/medium is allowed to quickly freeze to the desired temperature for cutting.

### BACKGROUND OF THE INVENTION

There are several ways of treating non-metastatic skin tumors. According to the AAD, the method that achieves the highest cure rate and the highest level of skin preservation is Mohs micrographic surgery. This method utilizes the Mohs surgeon for removal, diagnosis and repair. Routine surgical excision of the tumor requires the tissue to be sent to a laboratory for standard fixation and pathological review. Most reference laboratories offer standard turnaround times of anywhere from 48 hours to 1 week. Mohs micrographic surgery removes malignant cells and repairs surgical defects within the same office visit. It is the difference of hours to days and minimal scarring to avoidable defects.

Once the initial layer is removed, a map is made to designate orientation. The laboratory technician then freezes the tissue in such a way as to put the deep and lateral margins nearest to the cutting surface inside the cryostat. Sections are cut at between 4-10 microns and the sections are placed on slides, stained with nuclear and background stains and examined by the Mohs surgeon. It is critical for the technician to process tissue in as expeditious a manner as is possible while maintaining a very high level of precision. Once a complete layer is viewed microscopically and deemed free of tumor, the patient is declared cancer-free and the defect is surgically repaired. The patient can only be declared cancer-free when the entire layer is viewed. Layers are taken until the section is completely reviewed and found to be free of tumor.

Using current techniques to freeze the outermost epidermal layers of a removed tumor the specimen has to be manipulated with forceps or a scalpel until the epidermis is in a uniform plane. With this apparatus, the uniform plane is achieved without any manipulation than was utilized during the simple placement onto the freezing heatsink plane. By replacing the usual tissue receptacle (glass slides, plexiglass squares or the aluminum interior of the cryostat) with the aluminum heatsink plane, the tissue freezes quickly and precisely and therefore reduces the amount of preparation time significantly.

Because of the size of the plane and its composition, the aluminum heatsink plane provides the tissue with superior adherence, consistent reproducibility and structural uniformity to the traditional methods.

Additionally, utilizing current techniques require the use of scalpels and razor blades to reduce the footprint of the specimen stage. The introduction of a sharp instrument in a field that contains potential biohazardous material or bloodborne pathogens is an unnecessary risk this apparatus eliminates.

In relation to current systems commercially available, this apparatus is designed to be simple and universal. Unlike previously utilized methods this apparatus does not require the use of special adapters to make the apparatus functional with different cryostats nor does it require special hardware or physical change to the cryostat to utilize. It is a very simple design with the fewest parts necessary to achieve optimal results with any machine. It also does not utilize a cooling agent other than the inherent temperature of the cryostat's freezing chamber. The apparatus does not require canned freezing agents or liquid nitrogen.

### SUMMARY OF THE INVENTION

A principal objective of this invention is to improve patient outcomes by the provision of a system that operates as an adjunct to the Mohs micrographic surgical technique for diagnosing and treating cutaneous malignancies, but usage is not limited to Mohs. The system may also be used to facilitate the preparation of small samples such as biopsies for organ transplants. The key elements to improving patient outcomes result from minimized specimen footprint, better specimen uniformity, and specimen reproducibility. These improvements typically permit double the normal number of specimens on a single slide. Specimens can be read with fewer slides, improving diagnostic results and saving time.

Further objectives for this invention are to reduce the amount of consumable supply waste, as well as technician and patient time. The system reduces stress on the cryostat compressor by minimizing the amount of time the freezing chamber door is open. The cryostat is similar to a commercial food freezer, the longer the door is open and exposed to ambient room temperature, the harder the compressor has to work to maintain optimum freezing temperature. Because the embedding system components create a uniformly sized/shaped specimen each time, the amount of adjustment to the cryostat is eliminated almost entirely and therefore eases stress on certain adjustable cryostat components. The elimination of adjustment also decreases specimen preparation time. The uniform relationship between the planar surface of the specimen and the cryostat's chuck fixture also allows the technician to cut subsequent specimens and return to the first without adjustment.

Another objective of the system is to eliminate the potentially hazardous practice of cutting down the specimen stage. This has traditionally been achieved using a scalpel or razor blade. While the cryostat is in working condition and the surface is not sterile, any introduction of a sharp instrument into the freezing chamber is a potential for human contact with a possible deadly biohazard. The adjustable nature of this invention eliminates that unnecessary risk.

The simple nature of the invention allows tissue freezing to be efficiently achieved the first time. If there is an error in the process it is easily thawed and quickly re-frozen with minimal impact on tech/patient time.

The system is designed to be functional in all commercially available cryostats with no need for conversion appliances or adapters. It requires no special hardware or any irreversible physical modification to the cryostat to be utilized in any machine. The apparatus is simply placed inside the freezing chamber. If you decide to stop use of the apparatus it is simply removed from the freezing chamber and the cryostat is exactly as it was before the introduction of the device. As soon as the heatsink plane has reached the interior chamber's temperature, which takes approximately 30 minutes, the system is ready for use.

### BRIEF DESCRIPTION OF DRAWINGS

In order that the manner in which the above-recited and other advantages and objectives of the apparatus can be appreciated, a more particular description of the apparatus briefly described above will be rendered by reference to a number of specific embodiments which are illustrated in the appended drawings. Understanding that these drawings depict only typical embodiments of the invention and are not to be considered limiting in scope, the apparatus will be described and explained with additional specificity and detail through the use of accompanying drawings, in which:

FIG. 1 is a perspective view of the embodiment of the device.

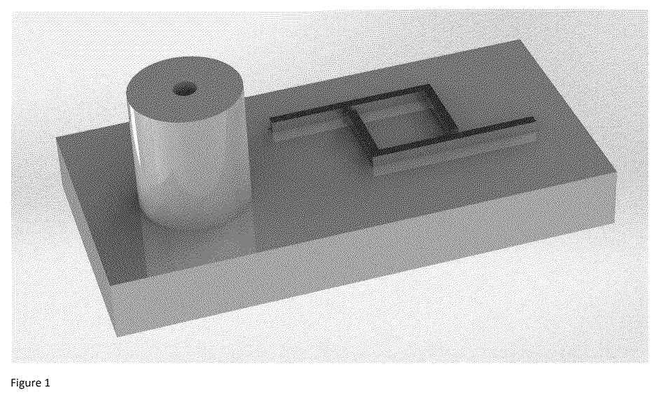

FIG. 2 is a perspective view of a cutaneous sample being frozen to the aluminum heatsink plane.

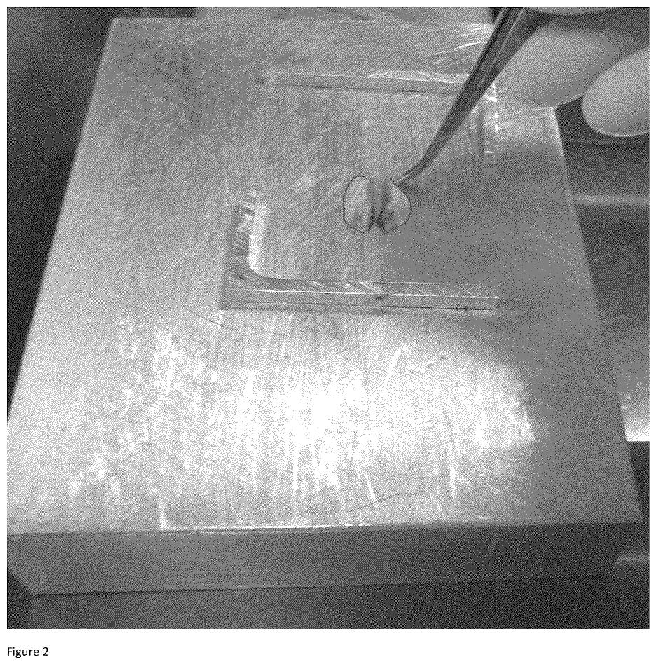

FIG. 3 depicts the adjustable specimen frames creating the smallest possible rectangle around the cutaneous sample.

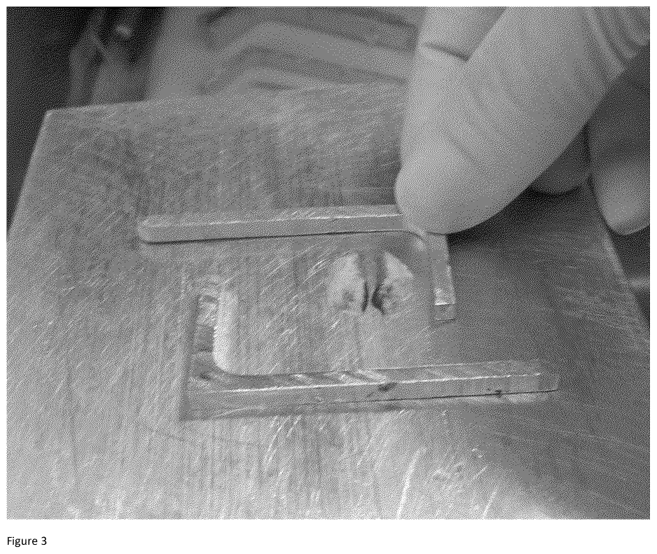

FIG. 4 depicts the specimen frames in final place and ready to be filled with embedding medium.

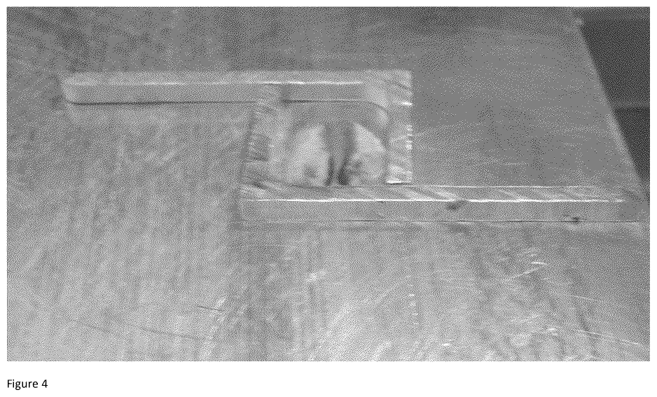

FIG. 5 depicts the specimen frame being filled with an embedding medium.

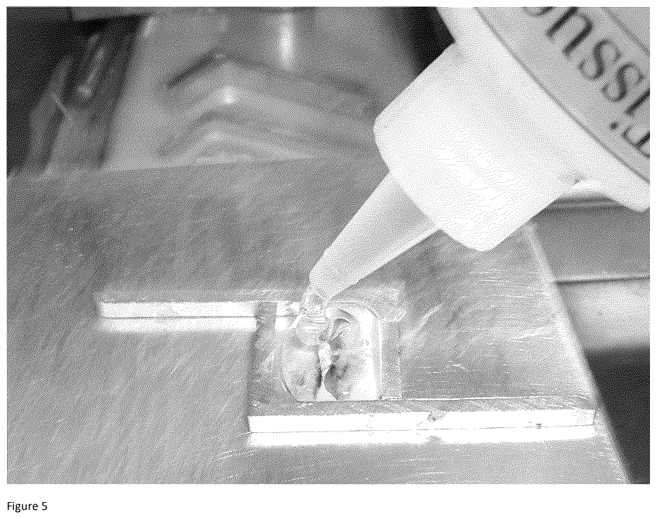

FIG. 6 depicts a specimen chuck (provided by the manufacturer of the cryostat being used) inverted to cover the specimen frame that surrounds the cutaneous specimen.

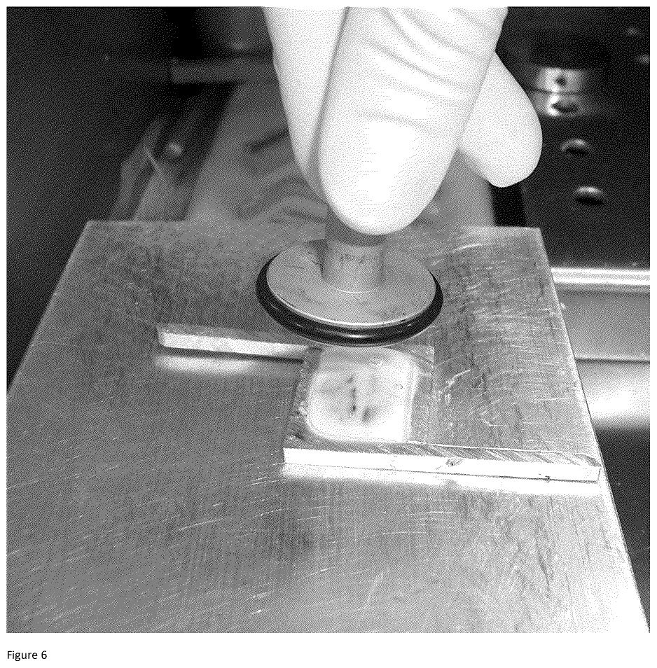

FIG. 7 shows placement of the over-tissue heat extraction cylinder on the specimen chuck stem.

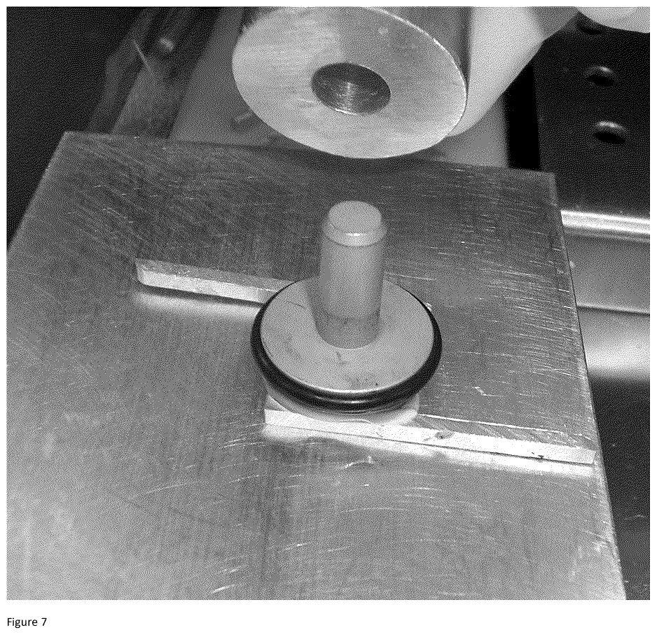

FIG. 8 shows a side view of the over-tissue heat extraction cylinder resting on aluminum specimen frames.

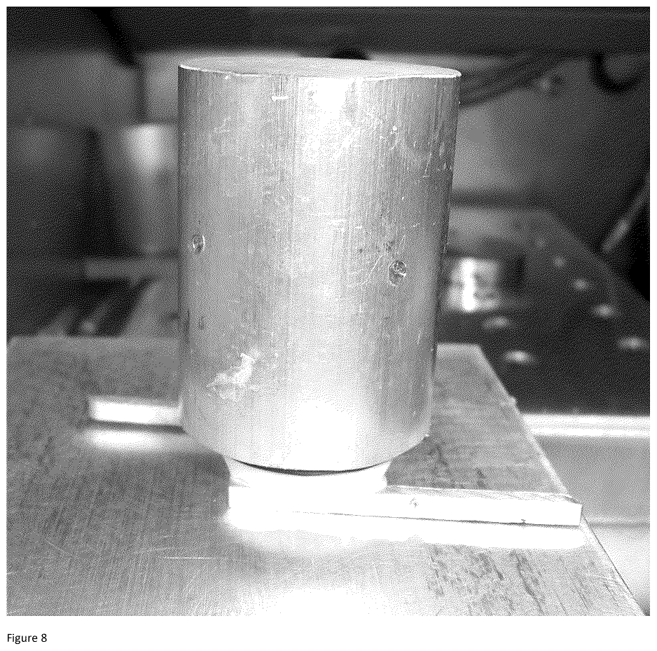

FIG. 9 shows a side view of the heat extraction cylinder being used to break the bond between the embedding medium and the aluminum heatsink plane.

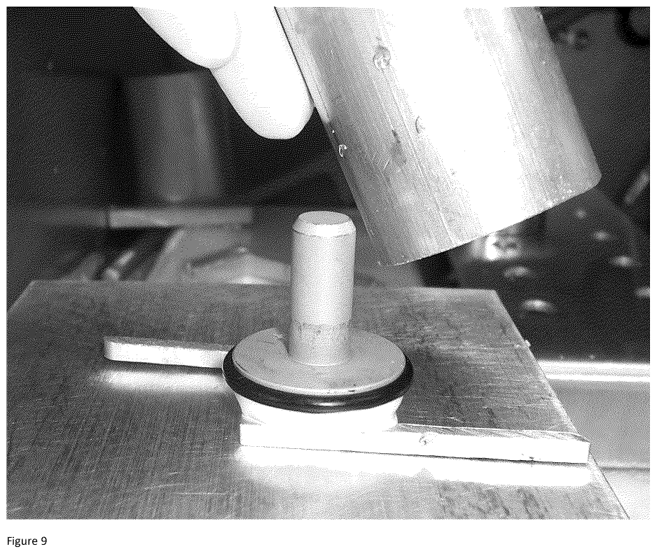

FIG. 10 shows a prepared cutaneous specimen, in the chuck holder of the cryostat, ready for cryo-sectioning.

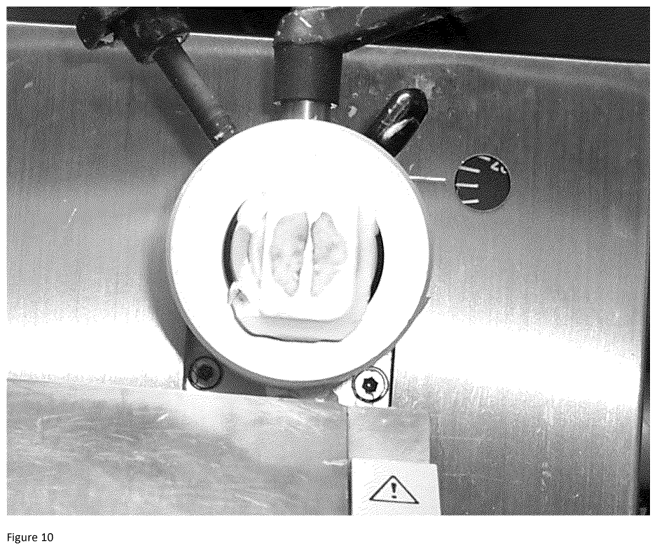

### DETAILED DESCRIPTION OF THE INVENTION

Reference is now made to the drawings, wherein numerals are used to designate figures throughout.

In use, the surgeon excises a cutaneous specimen from a patient, the specimen is brought into the laboratory containing the apparatus of the present invention, as well as a standard cyrostat. The specimen is mapped and inked by the laboratory technician, to indicate orientation of tissue that will correlate with the microscopic view of the final cryosection.

The inked cutaneous specimen is then frozen to the aluminum heatsink plane (2) with the epidermis side up. After ensuring the outer edges of the epidermis have been frozen on a uniform plane, the aluminum specimen frames (3 and 4) are adjusted to allow the smallest area of embedding medium (5) to surround the specimen and therefore creating the smallest block footprint possible. Creating the smallest possible specimen stage footprint will allow the technician to fit the maximum number of complete cryosections on the standard microscope slide.

After the specimen frame is filled with an embedding medium, a specimen stage (provided by the cryostat manufacturer) is inverted to cover the frame (6). The over-tissue heat extraction cylinder is applied (7 and 8), which aids in the rapid freezing of the specimen stage. Upon freezing, the heat extraction cylinder (9) is removed and used to tap the stem of the specimen stage (7) to break the bond between the heatsink plane and the embedding medium. The technician then removes the adjustable specimen frames and snaps off any extraneous embedding medium and inserts the specimen chuck into the cryostat's adjustable specimen chuck holder (10).

The present invention provides a rapid, precise means and method of preparing a tissue specimen stage for use in the pathological diagnosis of disease. Because of the ease of use and precision the simple design creates, the results are consistently reproducible. The simple design lends itself to easily be used in all commercially available machines without the burden of adapters or mechanical installation. The design eliminates certain biohazardous risks a user would expose themselves to utilizing current methods of tissue preparation. It also does not utilize some of the dangerous freezing agents other current techniques utilize.

Although this invention has been shown and described with respect to detailed embodiments thereof, it will be understood by those skilled in the art that various changes in form and detail thereof may be made without departing from the spirit and scope of the claimed invention.

1. A system designed to aid in the freezing of biological tissue for pathological/histological study comprising: an aluminum heatsink plane with flat smooth surface, a pair of adjustable aluminum specimen frames and an aluminum over-tissue heat extraction cylinder designed to fit over most commercially available specimen stages.

2. A method for preparing a tissue sample comprising the steps of: placing the tissue sample face down on the flat aluminum plane; surrounding the tissue with the pair of adjustable tissue frames and creating the smallest area of space between the tissue and the frames; filling the created specimen frame with embedding medium; placing a specimen chuck (specific to the cryostat being utilized and supplied by cryostat's manufacturer) over filled specimen frame; covering the specimen chuck with the over-tissue heatsink cylinder; and allowing the tissue/medium to freeze to the desired temperature for cutting.
